(19) United States
(12) Patent Application Publication
(10) Pub. No.: US 2023/0069222 A1
(43) Pub. Date: Mar. 2, 2023

(54) ADAPTIVE API TRANSLATOR

(71) Applicant: Seagate Technology LLC, Fremont, CA (US)

(72) Inventor: Joseph SKAZINSKI, Longmont, CO (US)

(21) Appl. No.: 17/401,137

(22) Filed: Aug. 12, 2021

(51) Int. Cl. G06F 9/54; G06F 8/41

(52) U.S. Cl. CPC G06F 9/541; G06F 8/427

(57) ABSTRACT

A method for translating data from one application programming format to another programming format is provided. The method includes receiving a request to provide data in a second application programming format from data in a first application programming format, retrieving an interpretation data object associated with the request and the second application programming format, the interpretation data object including data representing source data entities in the first application programming format and target data entities in the second application programming format, performing a function identified in the interpretation data object, the function performed on a value of the source data entities to yield a value of target data entities based on an association included in the interpretation data object between the function, the source data entities, and the target data entities, and providing the data in the second application programming format based on the value of the target data entities.

### BACKGROUND

Application programming interfaces (APIs) are software intermediaries that facilitate communication between applications. APIs can be standardized and used by any number of commercial entities or may be proprietary and specific to particular entities. Updates to APIs can cause communication issues between systems that rely on different APIs. These updates can be difficult to account for, especially for entities with limited resources. Also, commercial and technological factors often cause entities to transition to different APIs, effectively changing the APIs considered to be standard.

### SUMMARY

The described technology provides implementations of systems and methods for translating between application programming formats. For example, a method for translating data from one application programming format to another programming format is provided. The method includes receiving a request to provide output data in a second application programming format from input data in a first application programming format, retrieving an interpretation data object associated with at least part of the received request and the second application programming format, wherein the interpretation data object includes data representing one or more source data entities in the first application programming format and one or more corresponding target data entities in the second application programming format, performing a function identified in the interpretation data object, the function performed on a value of the one or more source data entities to yield a value of the one or more corresponding target data entities based on an association included in the interpretation data object between the function, the one or more source data entities, and the one or more target data entities, and providing the output data in the second application programming format based on the value of the one or more corresponding target data entities.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example adaptive API translation system.

FIG. 2 illustrates another example implementation of an adaptive API translation system.

FIG. 3 illustrates still another example implementation of an adaptive API translation system.

FIG. 4 illustrates example operations for processing a request from a client computing system.

FIG. 5 illustrates example operations for translating input data in a first application programming format into output data in a second application programming format.

FIG. 6 illustrates an example of a computing system that may be used to implement the technology disclosed herein.

### DETAILED DESCRIPTIONS

Translating between APIs can be difficult, and most entities attempt to do so with fixed programmatic schemes that can be difficult to modify over time. Entities may have to expend resources to make these translations that could otherwise be allocated to core, substantive functions of the entities' software solutions. Existing API translation solutions are static. For example, existing systems use a manifest to generate code, which is then compiled, linked, and used to run an application.

The disclosed technology includes an adaptive API translation system that can provide a run-time mechanism for translating data from one API format to another. The adaptive API translation system may effectively be componentized to separate elements of the adaptive API translation system that are expected to change with modifications to APIs and systems from elements of the system that are expected to remain static. For example, various data entities or objects of a first API and the values of those data entities in particular systems that use the first API can dynamically change with updates to the first API and the system. However, many elements or functions performed on the values of the data entities in the first API to translate the values for data entities in a target system that uses a second, different API remain consistent. For example, if the system using the first API includes values of “used space” and “free space” source data entities for a drive but does not include a source data entity representing “total space,” and the system using the second API requests data regarding the “total space” of the drive, the adaptive API translation system may perform an add operation to add the values of “used space” and “free space” source data entities to yield a value of the “total space” target data entity to be provided in the second API format. While the source data entities (e.g., used space and free space), the destination data entities (e.g., total space), and their respective values may change with time, the add operation may remain the same.

The adaptive API translation system may use a consistent command structure that relies on interpretation data objects with data that is more likely to change. The interpretation data objects may contain the translation between source data entities and destination entities, whether the translations be one-to-one translations between identities of source data entities and target data entities or they require a transformation on one or more values of source data entities to generate values of one or more target data entities.

In some implementations, a service may accept a request in a standard API format from an entity. The service may call a system commander executable by a computing system with a processor and memory to request the computing system to execute a proprietary command in a proprietary API format. The response from the computing system may be in a proprietary API format. The response may conform to a standard data representation, for example, a JavaScript Object Notation (JSON) file format, an extensible markup language (XML) format, or in CLI format. The system commander may then call a translator and pass the response with the data in the first application programming format to the translator. The translator may then use an interpretation data object and the response in the proprietary API format to produce translated data output object in the standard API format. The translated output data may be stored in a standard file format, for example, in a different JSON file. The system commander may then return the output data in the standard API format to the service to transmit to the requesting entity.

The interpretation data objects can be modified over time to represent changes in the relationship between data entities of different APIs. For example, updates to existing APIs may change names of data entities (e.g., changes to names of variables and/or property identifiers) or availability of data entities over time, which may require the interpretation data objects to be modified to account for the values. The interpretation data objects may be generated by a translation service or by an entity that generates data in an API format that may require translation for a requesting system using a different API format.

The interpretation data objects may be structured like a modularized set of relationships and operational sequences. In an implementation, the data in the interpretation data object may include a series of steps corresponding to a request. Each step may include at least one command that is interpreted by a system commander in a first API format. The command may be associated with one or more operations, each operation specifying a function to be performed, the source data entities on which the function is performed, and the target data entities associated with the result of the function performed. In some implementations, a function may require input of values of more than one source data entity to produce a single target data entity (e.g., for a multiplication or an add operation). These data structures may separate general functionality of a translator from data values and data entities specific to APIs and systems. In implementations, a second-level translation table that allows another level of mapping may be used between generic translation elements in a translator to API-specific elements.

By providing an API translator that separates generic functional elements from the ones that are specific to APIs or systems, the API translation can be adapted to changing circumstances by modifying the elements specific to the changing APIs or systems. An API translator with generic functionality can retrieve interpretation data objects specific to translation between specific APIs, such as data objects further specific to a request or elements of a request issued by a requesting entity. This allows the interpretation data object to be updated independently of the translator. Further, by separating the functional elements from the elements that are specific to particular API to API translations, the translation operations can be more easily conducted at runtime. For example, a translation service could provide a separate facility for uploading new interpretation data objects, thereby allowing the translation service to be adjusted to API changes without having to distribute new translator logic releases and updates. This may reduce the testing and risks associated with updates to a system in production. The interpretation data object may also represent data entities as keys in order to reduce the file size and to make a uniform translation operation for any given API to API translation. The keys may further provide a compact shorthand notation for value location in hierarchical data objects to better utilize compute resources and/or make the code more human-readable.

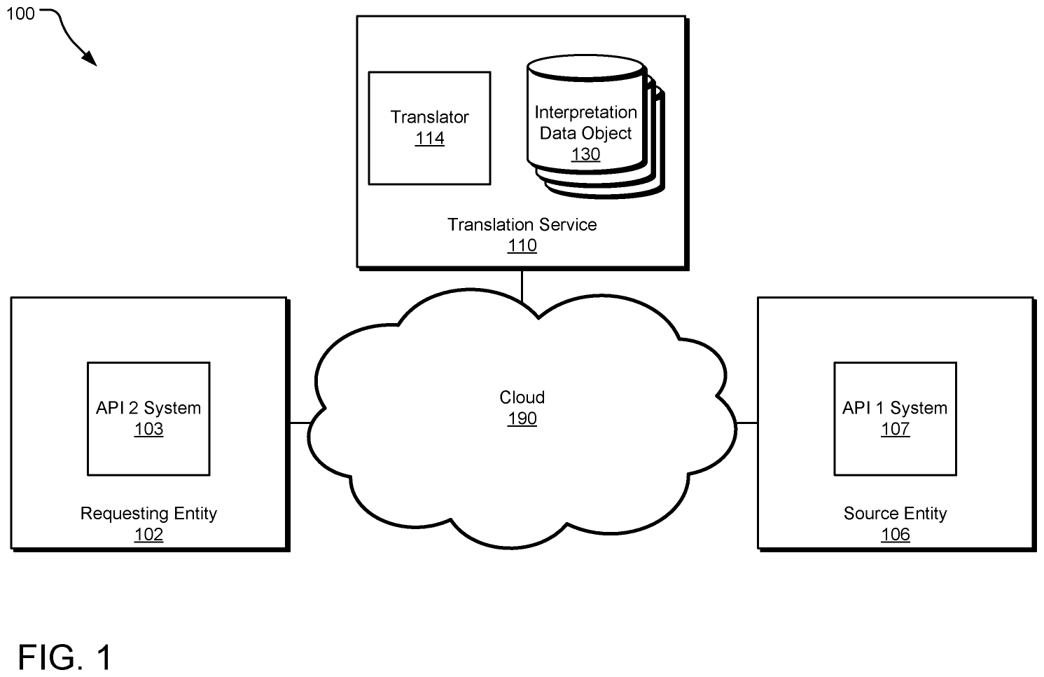

FIG. 1 illustrates an implementation of an adaptive API translation system 100. The adaptive API translation system 100 uses a translation service 110 to receive requests from a requesting entity 102 with a computing system that uses a second API (API 2 system) 103 to retrieve data from a source entity 106 with a computing system that uses a first API (API 1 system) 107. The first and second APIs differ from one another to the extent that data the requesting first entity 102 requests from the source entity 106 may need to be translated. The requesting first entity 102 may request from the translation service 110 data that is translated from corresponding data supplied by the source entity 106. The translation service 110 may provide data translation at run-time to process requests. In the illustrated example, the requesting entity 102, translation service 110, and source entity 106 communicate via the cloud 190. The cloud 190 is a system of networks (e.g., the Internet) and may include one or more of wired and wireless communication systems. While depicted as separate entities, one or more of the requesting entity 102, translation service 110, and source entity 106 can be controlled by the same entity or be elements of a same system such that communication may not be conducted over the cloud 109 between those entities or a same entity or same computing system.

The translation service 110 may include a translator 114 and one or more interpretation data objects 130. The translator 114 is an application that provides output data in a second API format by translating or otherwise interpreting input data provided in a first API format. The translator 114 retrieves an interpretation data object 130. The interpretation data object 130 may include identifying data associated with one or more of an element of a request from the requesting entity 102, a command sent from a commander, the first application programming format, and the second application programming format to provide the translator 114 with information to retrieve an interpretation data object 130 that can be used in a translation request.

The interpretation data object 130 can be packaged in any type of data format. For example, the interpretation data object 130 can be a discrete file or a discrete collection of data that is otherwise identifiable and retrievable. In an implementation, the interpretation data object is formatted as a string, for example, as a JSON format object or file. The interpretation data object 130 may include steps with commands (e.g., ones executable by a System Commander) and associated operations. Each operation may include data representing one or more source data entities in the first application programming format and one or more corresponding target data entities in the second application programming format and functions to operate on values of the one or more source data entities to generate at least one value of the one or more corresponding target data entities. In an implementation, each operation includes only one target data entity and/or results in producing only one output value for the target data entity. Also, in some implementations, each operation includes only one function. Data entities may be properties or other variables of systems that can be identified and retrieved as elements of requests. The translator 114 may provide the output data in the second API format to a commander or other system of the translation service 110.

In some implementations, data input into the translator 114 can include parameters passed from the commander or other administrator of the translation service 110. The parameters may include values of the one or more source data entities. The parameters may be passed as string data. In an implementation, when more than one parameter is passed, the parameters are passed as a single string to be parsed by the translator 114. The translator 114 may parse the single string and/or assemble any passed parameters into a variable table for use in a translation. In translations where no parameters are passed, the parameter string may be passed as an empty string. The parameters may be passed as parameter variables, or “pVariables” (illustrated in examples as elements in brackets starting with the letter, “p”). By passing the parameters as pVariables, the system can be adaptive and not use hard-coded values. The pVariables may be determined from the data received from API 2 System 103 of the requesting entity 102 (or from system constants), and initialized and passed into the translator 114. The translator 114 may use pVariables in conjunction with interpretation data objects 130 to formulate proper commands and parameters that are executed by API 1 System 107. The use of pVariables can provide an additional level of flexibility in reducing the number of hard-coded values used in interpretation data objects 130, potentially adding flexibility to the translation service 110.

Functions are operations applied to values of source data entities to yield target data entities. The functions may be specified in the interpretation data object 130, but instructions for performing the functions may be elements of the translator 114. This may separate the roles of the translator 114, which may contain elements generally expected to remain the same when systems and APIs change, and the interpretation data object 130, which may likely be modified when system values or APIs change. The interpretation data object 130 may contain references to data entities and functions for each operation of each step, but it may be limited to a reference element that does not execute any particular function. The translator 114 may retrieve the interpretation data object 130 to reference these relationships between entities and the functions used to translate the data entities in the relationships, but most if not all of the functionality may be elements of the translator 114. For example, the translator 114 may retrieve the interpretation data object 130 to reference which source data entities to retrieve, what function(s) to perform on the source data entities, and what target data entity to reference to store the result in output data.

The interpretation data object 130 may not itself execute anything but exist as a reference for this purpose. Further, the interpretation data object 130 may reference source and target data entities using key identifiers, but the translator 114 may be the entity with the functionality to translate between the key identifiers and identifiers of the data entities to be presented in input and output data objects (e.g., in the first and second application programming formats, respectively). Further, the translator 114 may interpret the hierarchical organization of the source data entities based on the structure provided in the input data to relate to source data entity keys and the hierarchical organizations to relate target data entity keys to output data. This structure may provide an interpretation data object 130 containing only or predominantly reference data that can be executed by other objects. This interpretation data object 130 can be readily modified to accommodate changes to the first and second application programming formats, as it may involve exclusively or predominantly modification of the reference to the commands, data entities, and/or the functions. However, over time the logic entity of the translator and the structure of the interpretation data object may need to be modified. For example, if a new function is needed, updates may be made to both the translator 114 and the interpretation data object 130 to accommodate the new function.

Examples of function operands may include, without limitation, one or more of ST_INVALID, ST_NONE, ST_ADD, ST_CONSTANT, ST_DIVIDE, ST_ENUM, ST_FORMAT, ST_MEMBER, ST_MULTIPLY, ST_PERCENT, ST_SELECT, ST_SUBTRACT, and ST_VARIABLE. Some functions may be merely to reference and/or copy values from data entities in a first application programming format to locations in output data that represent and are referenced as target data entities. These may include, for example, functions represented by function operands ST_NONE and ST_CONSANT.

Other functions may be transformational, for example, functions represented by operands ST_ADD, ST MUTIPLY, ST_PERCENT, ST_DIVIDE, ST_ENUM, ST_MULTIPLY 100, and ST_SUBTRACT. Some other functions transform using table values to associate source and destination data entities, for example, functions represented by functional operands ST_VARIABLE, ST_SELECT, ST_MEMBER, ST_FORMAT, and ST_ENUM. The interpretation data object 130 may also contain an unknown function type, which can cause a ST_INVALID operand to be returned. This may cause termination of the function. Table 1 provides explanations of these exemplary function operands.

TABLE 1
Exemplary Function Operands

| Function | Description | Source |
|---|---|---|
| ST_INVALID | Returned when an interpretation data object 130 contains | |
| | an unknown function type. The translation may | |
| | terminate when a ST_INVALID is encountered. | |
| ST_NONE | Retrieve the source property and store it as is, without | 1 |
| | any transformation. | |
| ST_ADD | Convert all source values to uint64 and add the values | 1 . . . N |
| | together. A single destination value is stored. | |
| ST_CONSTANT | Store all source values as destination values with no | 1 . . . N |
| | retrieval and no transformation. | |
| ST_DIVIDE | Divide the first specified source value by the second | 2 |
| | specific source value. | |
| ST_ENUM | Store the source value but use the table specified to | 1 |
| | transform the source value into the appropriate | |
| | designation value based on the key-value pairs specified. | |
| | A filter may be used to select the correct item from an | |
| | array of items. See Table 2. | |
| SF_FORMAT | Store all the source values using a “link” format | 1 . . . N |
| | specified. See Table 2. | |
| ST_MEMBER | Store the source values using a “link” format specified, | 1 . . . N |
| | but also use the specified “filter” to possibly reduce the | |
| | final number of destination values. See Table 2. | |
| ST_MULTIPLY | Convert all source values to uint64 and multiple them. A | 1 . . . N |
| | single destination value is stored. | |
| ST_MULTIPLY_100 | Convert a singular source value to uint64 and then | 1 |
| | multiple it by 100. A single destination value is stored. | |
| ST_PERCENT | Divide the first specified source value by the second | 2 |
| | specific source value and then multiple by 100 to create | |
| | a percentage. If the numerator is 0, store 0%, and if the | |
| | denominator is 0 store 100%. | |
| ST_SELECT | Used to select a particular source value based on a filter | 1 |
| | key and filter value. See Table 2. | |
| ST_SUBTRACT | Create a destination value based on the first source value | 2 |
| | minus the second source value. A single destination | |
| | value is stored. | |
| ST_VARIABLE | Use the variable table to convert the variable. | 1 |

Additional functions may specify an optional “table property.” This may be used to perform a transformation of source data entity values based on an enumeration table, link formula, or filter. Exemplary translation functions with optional table properties include ST_ENUM, ST_FORMAT, ST_MEMBER, and ST_SELECT, as explained in Table 2.

TABLE 2
Exemplary Functions With Optional Table Properties

| Function | Description |
|---|---|
| ST_ENUM | For ST_ENUM, the table property may contain a comma-separated list of |
| | key=value pairs. The table may be used to transform the source value into the |
| | target value using the table as a look-up table. Example: |
| | “table”: “values=0-None;1-None;2-None;3-SelfEncryptingDrive;4- |
| | SelfEncryptingDrive;5-Other” |
| | In this example, the property “fde-state-numeric” is read as a source value, |
| | and then based on that integer value, a string is determined using the function |
| | table. If fde-state-numeric was 4, then the string “SelfEncryptingDrive” is |
| | stored as the destination value. |
| | The keyword ‘values=’ is used to extract the enumeration values. Enumeration |
| | key pairs are separated by a semicolon (;) and the enumeration key and value |
| | are separated by a dash (-). For example: values=1-value1;2-value2. |
| | In addition, a filter value can also be used with this function to extract the |
| | correct source based on a filter key and filter value. The ‘filter’ key-value pair |
| | may be added to the table and separated by other key-value pairs by a comma |
| | (,). For example: “filter=durable-id:{pName}” This may only return sources |
| | where the durable-id is equal to the pName passed in by the caller. There may |
| | be a default-value pair that allows the interpretation data object 130 to specify a |
| | default target value when the source value does not match any keys in the |
| | enumeration table. |
| ST_FORMAT | For ST_FORMAT, the table contains a comma-separated list of key=value |
| | pairs. The only key supported is “link”. |
| | The “link” key is used to specify a uniform resource identifier (URI) type of |
| | variable, which can contain both pVariables and tVariables. For example: |
| | std::string pVariables = “pLinkChassis=/redfish/v1/Chassis”; |
| | “table”: “link={pLinkChassis}/enclosure_{tSource}” |
| | This function looks up a source value and replaces {tSource} with that |
| | retrieved value. It then creates a new string where {pLinkChassis} is replaced |
| | with the passed value, thereby creating a full path string. If tSource was 0, |
| | then a final destination value would be “/redfish/v1/Chassis/ enclosure_0”. |
| ST_MEMBER | For ST_MEMBER, the table contains a comma-separated list of key=value |
| | pairs. The keys supported are “link” and “filter”. |
| | The “link” key is used to specify a URI type of variable, which can contain |
| | both pVariables and tVariables. |
| | The “filter” key is used to specify a property key and value, and only entities |
| | including that key and value are returned. |
| | For example: |
| | pVariables = “pLinkDrives =/redfish/v1/StorageServices/S1/Drives,pSerial= |
| | 00c0ff5112460000ea51725e00000000”; |
| | “table”: “link={pLinkDrives}/{tSource},filter=virtual-disk-serial:{pSerial}” |
| | This function will search through the source data looking for a particular |
| | source property, and then only save that property if virtual-disk-serial is equal |
| | to 00c0ff5112460000ea51725e00000000. |
| | Then the final link will be computed. This function will use the returned |
| | source values and replace {tSource} with those values. It will then create a |
| | new string where { pLinkDrives } is replaced with the passed in value, |
| | thereby creating a full path string. If tSource was 0.0, then final destination |
| | value would be “=/redfish/v1/StorageServices/S1/Drives/0.0”. |
| ST_SELECT | This function is used to select a given source from the source data using a |
| | particular filter. This function allows the correct source value to be chosen |
| | when the source value data contains an array of various entities such as |
| | controllers or volumes. |
| | In this example, we produce an “Id” property. The source is based on the |
| | JSON property “controller-id” found in an array of controllers. The filter key |
| | “durable-id” is used to find the correct controller with the value “{pName}” |
| | which is passed into the translation call along with the interpretation data |
| | object 130. The “link” table key-value pair can be a mixture of text and |
| | variables, or as in this case, the simple {tSource} value which produces a |
| | destination string equal to the source value. An example interpretation data |
| | object 130 using a JSON format is: |
| | {pIndex} = 0 |
| | {pName} = controller_a |
| | { |
| | “target”: { “key”: “Id”, “type”: “ST_STRING” }, |
| | “sources”: [ { “key”: “controllers/{pIndex}/controller-id” } ], |
| | “function”: “ST_SELECT”, “table”: “link={tSource},filter=durable- |
| | id:{pName}” |
| | }, |
| | An example source JSON is: |
| | { |
| | “controllers”: [ |
| | { |
| | “object-name”:“controller”, |
| | “durable-id”:“controller_a”, |
| | “controller-id”:“A” |
| | }, |
| | { |
| | “object-name”:“controller”, |
| | “durable-id”:“controller_b”, |
| | “controller-id”:“B” |
| | } |
| | ] |
| | } |
| | The resulting example target data output JSON may be: |
| | { |
| | “Id”: “A” |
| | } |

In implementations, the translator 114 uses translator variables, or “tVariables” (illustrated in examples as elements in brackets starting with the letter, “t”). Translator variables can be used in translation operations to process the translation. Exemplary translator variables may include one or more of {tSource}, {tSource1}, {tSource2}, {tMemberIndex}, and {tMemberCount}, as described in Table 3. The tVariables may be internal variables of the translator 114, The tVariables can be used in the interpretation data object 130 to increase the flexibility of the system 100 and/or to reduce the number of updates required.

TABLE 3
Exemplary Translator Variables

| Variable | Description |
|---|---|
| {tSource} | This variable is filled in by the last source value obtained from processing the |
| | results of the data obtained from API 1 system 107 based on a step outlined in |
| | an interpretation data object 130. It can be used to fill in a link to a collection |
| | member. |
| {tSource1} | This variable is used when multiple source values are required to build a |
| | target string. |
| | For example: “link={pLinkStorageGroups}/{tSource1}-{tSource2}” |
| {tSource2} | This variable is used when multiple source values are required to build a |
| | target string. |
| | For example: “link={pLinkStorageGroups}/{tSource1}-{tSource2}” |
| {tMemberIndex} | This value may be set during a translation, specifically, it may be set during a |
| | third step of a translation operation when each of the destination values is |
| | processed. This variable is incremented from 0 to the total number of |
| | destination values minus one. It may be used to indicate the various members |
| | of an array collection in an interpretation data object 130. |
| {tMemberCount} | This value is set equal to the total number of target values found when |
| | processing an interpretation data object 130. It may be used to specify the |
| | total number of members in an array collection. |

The tVariables may be initialized when the translator 114 first processes an interpretation data object 130. The tVariables may be maintained by the translator 114 logic to track a variety of values that may prove useful for the creation of values of the target data entities. For example, tVariables can be used to track the total number of array elements in a particular grouping, as well as the index of the current group member being processed. The tVariables can also be used to track the current source value, when multiple values are extracted, thus enabling the interpretation data object 130 to produce a grouping of target values as needed by the API 2 system 103. When the processing of an interpretation data object 130 is complete, the tVariables are no longer used.

The interpretation data object 130 may use a special “key” identifier syntax to inform a translator 114 to relate a data entity to a corresponding identifier in an input or output data file. Data entities (e.g., source data entities and/or target data entities) may be represented in input or output data as hierarchically arranged data entities in the first or second application programming format. Examples of this “key” syntax are presented in Table 4 as emboldened entries.

TABLE 4
Exemplary Key Syntax

| Example | JSON Example (Input or Output Data) |
|---|---|
| “sources”: [ { “key”: | { |
| “volumes/{pIndex}/serial-number” } ], | “volumes”: [ |
| “function”: “ST_NONE” } | { |
| | “serial-number”:“00c0ff5112” |
| | } |
| | ] |
| | } |
| | Result: “00c0ff5112” |
| “sources”: [ { “key”: | { |
| “volumes/{pIndex}/blocks” }, { “key”: | “volumes”: [ |
| “volumes/{ pIndex }/blocksize” } ], | { |
| “function”: “ST_MULTIPLY” } | “blocks”:195305472, |
| | “blocksize”:512 |
| | } |
| | ] |
| | } |
| | Result (1): “195305472” |
| | Result (2): “512” |
| | Result (final): “99996401664” |
| “target”: { “key”: “Status/Health”, “type”: | { |
| “ST_STRING” } | “Status”: { |
| “target”: { “key”: “Status/State”, “type”: | “Health”: “OK”, |
| “ST_STRING” } | “State”: “Enabled” |
| | } |
| | } |
| “target”: { “key”: “CapacityBytes”, “type”: | { |
| “ST_INT” } | “CapacityBytes”: 99996401664, |
| | } |
| “target”: { “key”: “Encrypted”, “type”: | { |
| “ST_BOOLEAN” | “Encrypted”: false |
| | } |

In Table 4, the “Example” column shows data entities with key representations that correspond to labels, hierarchies, and results in the input data or output data illustrated as JSON data in the “JSON Example” column. In an implementation, a compact syntax can indicate how the input data object is to be parsed. For example, a slash (“/”) represents a change in level in the hierarchical input data object, and an integer value (0, 1, 2, etc) represents an array index. Variables such as indexes (e.g., {pIndex}) can be replaced with integer values provided by the system 100 to represent an array parameter value but can be separated by slashes in the key format like other hierarchical levels.

In the examples presented, slashes in the “Example” column are represented in the “JSON Example” column as sub-bracketed entries. The first two examples also present “source” data elements and “function” portions of operations in the “Example” column with corresponding representations in the resulting string “JSON Example” format. The last three examples present “target” data element portions of operations in the “Example” column with corresponding representations in the resulting string “JSON Example” format. It should be appreciated that, despite type information being passed into the “JSON Example” entries, the “JSON Example” entries are represented as string data that can be presented in a single string output data object and/or file. The key variables may be used internally in the interpretation data object 130.

The examples in Table 4 also illustrate that type data associated with the target data entity values can be specified in the “Example” column and implicitly reflected by the presentation of the data in the “JSON Example” column. The last three examples in Table 4 include target data entities specified data types as strings (ST_STRING), an integer (ST_INT), and a Boolean (ST Boolean). Table 5 presents Exemplary data types with accompanying explanations. The types in the “JSON Example” data may be interpreted from the presentation within the JSON format. For example, strings are presented between parentheses. Booleans take values of True or False. Ints can take integer values. Floating points can take one more of numbers with decimals or numbers larger than can be contained by an integer type variable. Other data types are also contemplated (e.g., UINT64 for larger positive numbers).

TABLE 5
Exemplary Data Types

| Function | Description |
|---|---|
| ST_BOOLEAN | Store the destination value as a JSON boolean. |
| ST_FLOAT | Store the destination value as a JSON |
| | floating-point value. |
| ST_INT | Store the destination value as a JSON integer. |
| ST_STRING | Store the destination value as a JSON string. |

One or more of interpretation data objects 130, input data (provided in response to a request), or output data (translated from the input data) may be in any format. For example, they may be entirely or largely composed of strings (e.g., in JSON format). The string data can be interpreted within the JSON format or any other format as conforming to different data types when used by the requesting entity 102 (e.g., when the requesting entity 102 receives a response based on output data output by the translator 114 and interprets data type properties for target data entity values in output data).

The translation operation conducted by the translator 114 can use a number of different workflows. One example workflow begins with clearing any prior variable table settings, and then updating the variable table using a pVariables string passed in by the caller if any parameters are elements of the input data. In an implementation, only the pVariable type variables are converted at this point, since the tVariables may be used later for other steps in the process. In an implementation, during a translate step, the input data has already been retrieved from a SystemCommander of the translation entity 110. The translator 114 may process each “step” individually and sequentially using data in the interpretation data object 130. Each operation listed for a step may be processed. In an implementation, each operation may be performed in three steps. In a first step, for each source value specified, retrieve that property from the source input data using the key format specified, including the optional use of pVariables and tVariables, and store it in an array of strings. There may be a few special handlers for certain source functions (e.g., ST_CONSTANT, ST_MEMBER, or ST_VARIABLE, as explained with regard to Tables 1 and 2). In a second step, the translator uses a defined “function”, along with the optional use of pVariables and tVariables, to transform the source values into one or more destination values (e.g., functions described with regards to Tables 1 and 2). In a third step, each target data entity value is stored in the output data (e.g., an output JSON file) based on the data type specified. All steps and commands may be processed and in some implementations processed sequentially). The resulting output data is then returned to the system commander or other entity in order to be transmitted to a requesting entity.

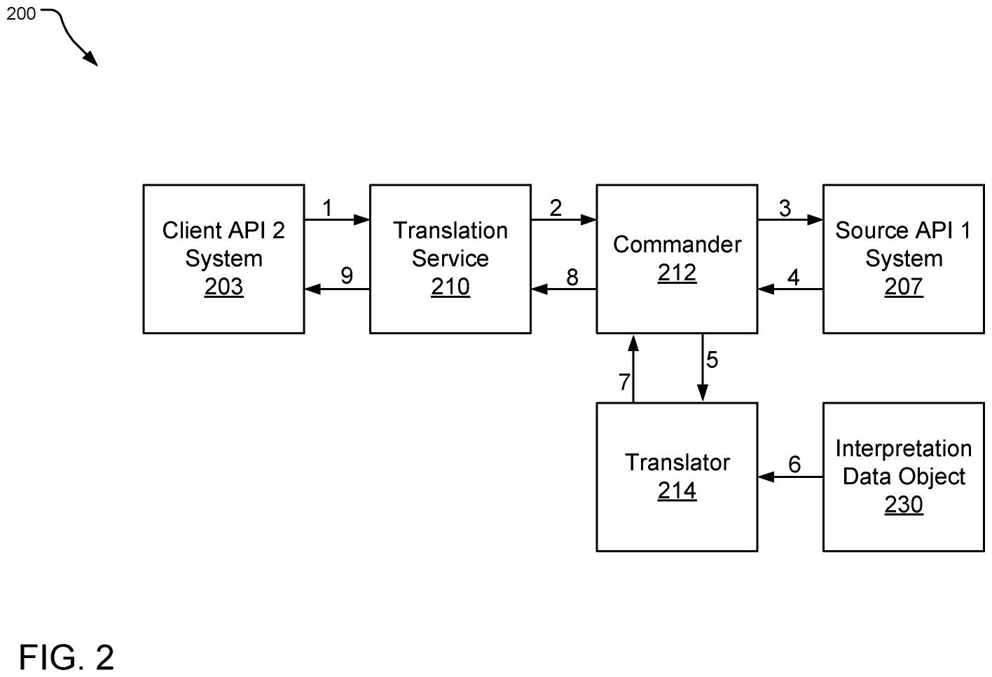

FIG. 2 illustrates another implementation of an adaptive API translation system 200. The adaptive API translation system 200 may be an implementation of the adaptive API translation system 100. The adaptive API translation system 200 facilitates information exchange between a client computing system using a second API programming format (Client API 2 System) 203 and a source computing system using a first API programming format (Source API 1 System 207). The translation service 210 is a service to facilitate translation and information exchange between the client API 2 system 203 and the source API 1 system 207. The translation service 210 may include a system commander 212 (alternatively, the commander 212 may be shared by the translation service 210 and the source API 1 system 207 if controlled by the same entity). The translation service 210 may instruct a translator 214 to use an interpretation data object 230 to translate data provided by source API 1 system 207 in the first API format to provide requested data to the client API 2 system 203 in the second application programming format.

In communication 1, the client API 2 system 203 sends a request to the translation service 210 in a second application programming format. In communication 2, the translation service 210 calls a commander 212 to request that the source API 1 system 207 process a command in a first application programming format, and the commander makes the request in communication 3. In communication 4, the source API 1 system 207 provides a response to the commander 212 in the first application programming format. The data may be provided (by the commander 212 or the source API 1 system 207) as a specialized input data object or file. This specialized input data object or file can be in a proprietary JSON format but referenceable by keys specific to an interpretation data object 230. The keys may be translatable by the translator 214. In communication 5, the commander 212 calls the translator 214 to translate the input data. In communication 6, the translator 214 retrieves an appropriate interpretation data object 230. The appropriate interpretation data object 130 may be determined based on one or more of the first application programming format, the second application programming format, elements of the request, calls from the commander 212 to translate input data, and other commands issued from the commander 212. The translator 214 then translates the input data in the first application programming format to output data in the second application programming format. In communication 7, the translated output data is provided to the commander 212. In some implementations, the commander 212 processes the translated output data to be coalesced with or added to other output data. The overall output data is then further transmitted to the translation service 210 system in communication 8 to be further transmitted to the Client API 2 system 203 in communication 9.

The commander 212 is a hardware or software system executable by computing device hardware (e.g., a memory and processor system) to perform general functions of the translation service 210, and may process other functions beyond mere execution of requests and translations. In an implementation, a singular commander 212 object is instantiated at system boot time, and users obtain a pointer to that object in order to execute commands or execute and translate commands. This commander 212 object can create one of a number of possible versions of a SystemCommander. Examples of versions include a management controller (MC) for storage (e.g., MC for electronic data storage (EDS) storage arrays) that calls an MC command-line interface (CLI) to execute commands and return output data and/or a simulator for testing. The creation of this object may be based on a JSON configuration file.

The commander 212 may be an object created at boot time. The object may provide methods to create, access, and delete instantiation of a commander 212 base object which may include a base class that provides certain virtual functions. These virtual functions may include one or more of an execute( ) function that runs a command and returns data (e.g., JSON data) produced by the executed command. This may require a session string. Another exemplary virtual function is an “executeAndTranslate( )” that runs a command to generate proprietary formatted data (e.g., in JSON format) and receives updates to the generated data from a translator to provide the output data in a format usable by the Client API 2 system 203. This function may require that parameters be specified in a call to the translator. This function may also require a session string.

In an implementation, the commander 212 calls a system commander framework container object based on a commander 212 type specified. The string command passed in may be executed using executeCommandToText( ) storing the output in a BufferStream (e.g., in JSON format). The call can handle converting the output buffer text into a data object (e.g., into a JSON or other data object). This object may provide a common routine to process the results of the call—“processResults( ).” The routine examines the (JSON or other) data object using a numeric property to determine if the command passed or failed. If the resulting data object needs translation, it includes input data to be translated by the translator 214. The object handles the execution of a command and runs an interpretation data object 230 to translate that data into application programming format-specific data. In an implementation, an interpretation data object 230 file is read into memory and converted into an interpretation data object 230. Each step in the interpretation data object 230 is executed and the data is translated and merged into the common output data object that is returned to the caller.

The translator 214 is a hardware or software system executable by computing device hardware (e.g., a memory and processor system) to perform translations from a particular application programming interface format to another application programming interface format. The commander 212 may be composed of its own proprietary format and/or may share an application programming format with the source API 1 system 207. The commander 212 issues output data and commands in a format that may be the same as or different from the second application format. In an implementation, the translator 214 uses the interpretation data object 230 to translate commands in a (first) proprietary data format into a different (second) application programming format. For example, the translator 214 translates a file in proprietary format to a standard API format (e.g., Redfish or Swordfish API JSON format). The translator 214 may represent a class of objects the commander 212 can call to instantiate a translation. In implementations, one or more of the translation service 210, commander 212, translator 214, interpretation data object 230, and source API 1 system 207 may be commonly controlled by the same entity and/or may be elements of a single or commonly controlled computing system.

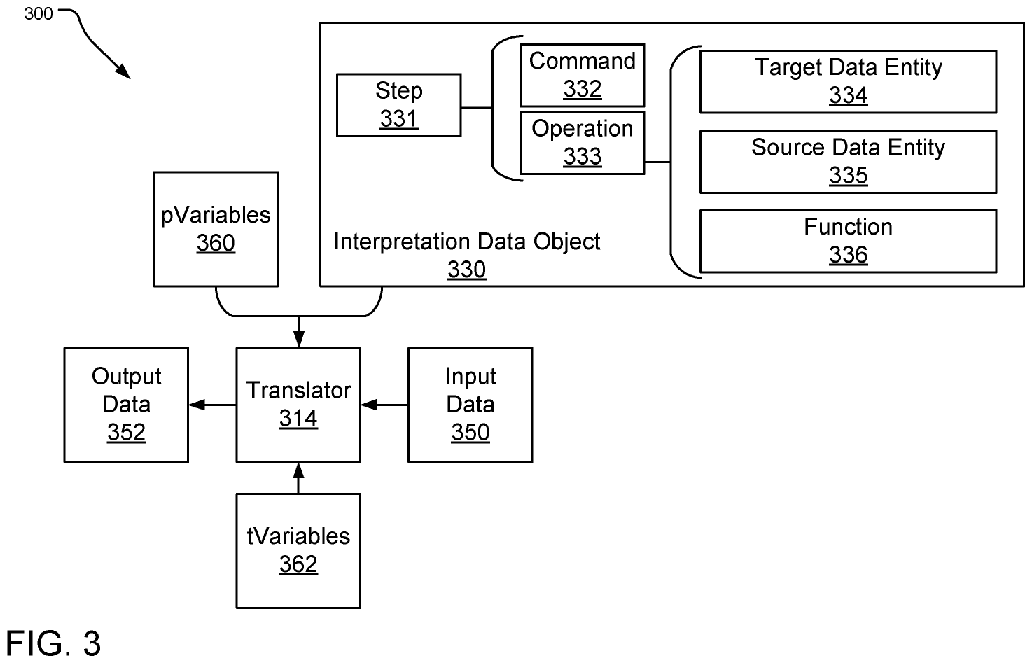

FIG. 3 illustrates still another implementation of an adaptive API translation system 300. The adaptive API translation system 300 shows that a translator 314 passes pVaraibles 360 and retrieves an appropriate interpretation data object 330 to translate input data 350 to output data 352. Although not illustrated, the pVariables may be populated using elements of the input data 350 and/or may be otherwise specified in a call or separate parameter value string.

The interpretation data object 330 includes at least one step 331. While only one step 331 is illustrated, the interpretation data object can include any number of steps 331. In an implementation, each step 331 includes a command 332 corresponding to a command that is made by a commander and one or more operations 333 to be used to translate the input data 350. Each operation 333 can be segmented into a target data entity 334, one or more source data entities 335, and a function 336. The values of the source data entities 335 may be derivable from one or more of the pVariables 360, the input data 350, and any values passed as parameters to the translator 314. The pVariables 360 and other values of source data entities 335 may be populated in a specialized table for parameter values. In some implementations, the pVariablse 360s and other values of source data entities 335 may be populated in the specialized table before any functions 336 are executed. The target data entities 334 are configured to be stored in output data 352 as specified in the interpretation data object 330.

Any of the target data entities 334, source data entities 335, and functions 336 may be stored in a key format that is used internally in the interpretation data object to relate target data entities with source data entities in a translation. When executing an operation 333, the translator retrieves values of the source data entities 335, executes the function 336 on the values of the source data entities 335, and outputs values of the target data entities 334 using a format specified in the translator 314 based on the interpretation data object 330. Exemplary functions are presented with regard to Tables 1 and 2. The tVariables 362 are used and populated internally in the translator 314. Examples of tVariables 362 and how they are used are presented with regard to Table 3. The tVariables are values computed or tracked by the translator 314 that can be used to flexibly determine the output data 352. They differ from pVariables in that they are internal to the translator 314.

The following is an exemplary interpretation data object 330 in code.

```
{
  “steps”: [
    {
      “command”: “show volumes {id} detail”,
      “ops”: [
        {
          “target”: { “key”: “Id”, “type”: “ST_STRING” },
          “sources”:
          [
            { “key”: “volumes/{pIndex}/serial-number” }
          ],
          “function”: “ST_NONE”
        },
        {
          “target”: { “key”: “Status/State”, “type”: “ST_STRING” },
          “sources”:
          [
            { “key”: “volumes/{pIndex}/health-numeric” }
          ],
          “function”: “ST_ENUM”, “table”:
          “values=0-Enabled;1-Disabled”
        },
        {
          “target”: { “key”: “CapacityBytes”, “type”: “ST_INT” },
          “sources”:
          [
            { “key”: “volumes/{pIndex}/blocks” },
            { “key”: “volumes/{pIndex}/blocksize” }
          ],
          “function”: “ST_MULTIPLY”
        },
        {
          “target”: { “key”: “RemainingCapacityPercent”, “type”:
          “ST_INT” },
          “sources”:
          [
            { “key”: “volumes/{pIndex}/allocated-size-numeric” },
            { “key”: “volumes/{pIndex}/total-size-numeric” }
          ],
          “function”: “ST_PERCENT”
        },
        {
          “target”: { “key”: “CapacitySources/{pIndex}/Name”, “type”:
          “ST_STRING” },
          “sources”:
          [
            { “key”: “volumes/{pIndex}/volume-name” }
          ],
          “function”: “ST_NONE”
        }
      ]
    },
    {
      “command”: “show fde-state”,
      “ops”: [
        {
          “target”: { “key”: “Encrypted”, “type”: “ST_BOOLEAN” },
          “sources”:
          [
            { “key”: “fde-state/{pIndex}/fde-security-status-numeric” }
          ],
          “function”: “ST_ENUM”, “table”:
          “values=0-false;1-false;2-true;3-true;4-true”
        },
        {
          “target”: { “key”: “EncryptionTypes/{pIndex}”, “type”:
          “ST_STRING” },
          “sources”:
          [
            { “key”: “NativeDriveEncryption” }
          ],
          “function”: “ST_CONSTANT”
        }
      ]
    },
    {
      “command”: “show volume-statistics {id}”,
      “ops”: [
        {
          “target”: { “key”: “IoStatistics/ReadHitIORequests”, “type”:
          “ST_INT” },
          “sources”:
          [
            { “key”: “volume-statistics/{pIndex)/read-cache-hits” }
          ],
          “function”: “ST_NONE”
        }
      ]
    }
  ]
    }
```

This example is not intended to be limiting but is presented for demonstration. This interpretation data object 330 includes three steps 331. The first step 331 includes a command 332, “show volumes {id} details”, where {id} specifies a volume identifier. Five operations 333 accompany this command. In the first operation, the source data entity 335 is a “serial-number” of the volume in the first application programming format, and the corresponding target data entity 334 is an “ID” in a second application programming format. The function is specified as “ST_NONE,” which copies the value of the source data entity 335 to a location for the value of the corresponding second application programming format target data entity 334 specified as string type data in an output data object 352.

The second operation 333 uses an ST_ENUM function 336 to take a “health-numeric” value in a table from the source data entity 335 in a first application programming format and store it as a second application programming format “State” target data entity 334 output value as a subset of the “Status” directory of the output data 352 specified as string type data. The third operation 333 includes a function 336 that multiplies values of the source data entities 335 “blocks” and “blocksize” (with key reference to the appropriate directories) in the first application format to yield a value of the second application programming format target data entity 334, “CapacityBytes” in the output data 352 specified as integer type data.

The fourth operation 333 takes a percentage of source data entity value 335 “allocated-size-numeric” relative to source data entity 335 value “total-size-numeric” in a first application programming format using an ST_MULTIPLY function 336 and yields a second application programming format target data entity value, “RemainingCapacity Percent” in the output data 352 specified as integer data type data. The fifth operation 333 of the first step 331 uses an ST_NONE function to copy a value of the “volume-name” source data entity 335 in the first application programming format to a second application programming format “Name” target data entity 334 value specified as string data in the output data 352.

The second step 331 includes the command 332, “show fde-state,” which includes two corresponding operations 333. The first operation 333 uses an ST_ENUM function 336 to receive a value of the source data entity 335 “fde-security-status-numeric,” interpret this in the context of the provided table in the first application programming format to determine an output that is true or false, and output that value as a value of the second application programming format “Encrypted” target data entity 334 specified as Boolean data in the output data 352. The second operation 333 of the second step 331 uses the ST_CONSTANT function 336 to provide a value of the “NativeDriveEncryption” source data entity in the first application data format as an element of a second application programming format target data entity 334 with a directory of “EncryptionTypes” specified as string type data in the output data 352.

The third step 331 includes command 332, “show volume-statistics {id}” and a single accompanying operation 333. The operation 333 uses an ST_NONE function 336 to copy a value of a “read-cache-hits” source data entity 335 in the first application programming format to yield a value of the second application programming format target data entity 335, “ReadHitIORequests” specified as integer type data in the output data 352.

The output data 352 may be structured to represent directories and other file hierarchies as sub-bracketed elements. When a key-value incudes a slash in it, it may imply that the element right of the slash is a subelement in a directory of the element to the left of the slash. These may be structured in corresponding JSON files as sub-brackets of bracketed elements. For example, an element to the left of a slash may be a sub-bracketed element of the element left of the slash.

It should be appreciated that even though the entire interpretation data object can be presented in a string (e.g., in JSON format), types of data can be appropriately distinguished using the type specifications. In this way, elements can be passed from the translator 314 to a commander in a string-type format (e.g., JSON) despite representing any type of data and can be presented to the commander in a manner understandable to a requesting entity that uses a different application programming format.

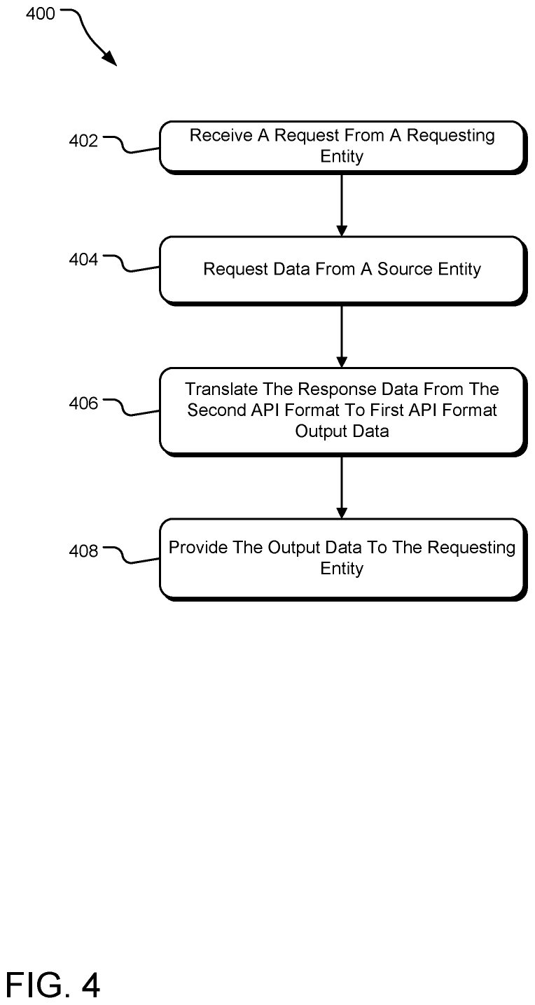

FIG. 4 illustrates example operations 400 for processing a request from a client computing system. Receiving operation 402 is receiving a request from a requesting entity that uses a second application programming format. A translation service may receive the request. The translation service may include or otherwise be in communication with a source entity or system that provides data in a first application format. The request may instantiate or may be received by an already instantiated commander.

Requesting operation 404 requests from the source entity data responsive to the request in the first application format. The request may be made by the commander. The commander may instruct the source entity to provide the response in a specific format or may receive the response data in a format the commander manipulates to make the response data more ingestible by a translator. For example, the commander may represent the response data in a hierarchical format that can be readily interpreted by a translator as corresponding to key identifiers in an interpretation data object. In implementations, the commander and source entity may be in a same system or controlled by the same entity, making the request an internal systems request.

Translating operation 406 translates by a translator the response data from the first application format to the second application format. The translating operation 406 may be an implementation of operations 500. The translator may receive the response data from the source system or entity and may retrieve an interpretation data object corresponding to one or more of the first application programming format, the second application programming format, the request, a command from the commander, and a call for the translator. The translator may populate pVariables with any parameters passed in the translator call. The translator may receive pVariables in a single string and parse them to be assembled in a variable data table. The input data may include the parameter string or may be separate. The variable data table may be cleared to allow for further variables each time a new translate call is made, a step is finished, an operation is finished, or the like. The translator may use internal tVariables that are populated while functions are being processed (e.g., like temporary variables) to keep track of how many expected targets have been processed. For exemplary tVariable functions, see Table 3. The translator may interpret one or more of the input data and the passed parameter string to determine values of source data entities. The translator uses the interpretation data object to perform functions on values of the source data entities to produce values of target data entities. The values of the target data entities are presented, as specified by the interpretation data object (and interpreted by the translator) in the output data with naming conventions and hierarchies specific to the second application format. The translator may relate key identifiers used to represent source and target data entities within an interpretation data object to identifiers used to identify the source and target data entities in the first and second application programming formats in the input and output data. The interpreter may readily translate the source and target data entities using hierarchical conventions applied to key values internal to the interpretation data object. The input data to be translated may be input as a data object (e.g., a string or JSON type object), and translated data may be yielded as a different data object (e.g., a different string or JSON type object).

Providing operation 408 provides the output data to the requesting entity. The output data may be provided by the translator to other elements of the translation service or commander to be transmitted to the requesting entity. In implementations where the translated data is only a part of the data to be transmitted to the requesting entity, the commander or other element of the translation service may incorporate the translated output data with other output data to be provided to the requesting entity to satisfy a request.

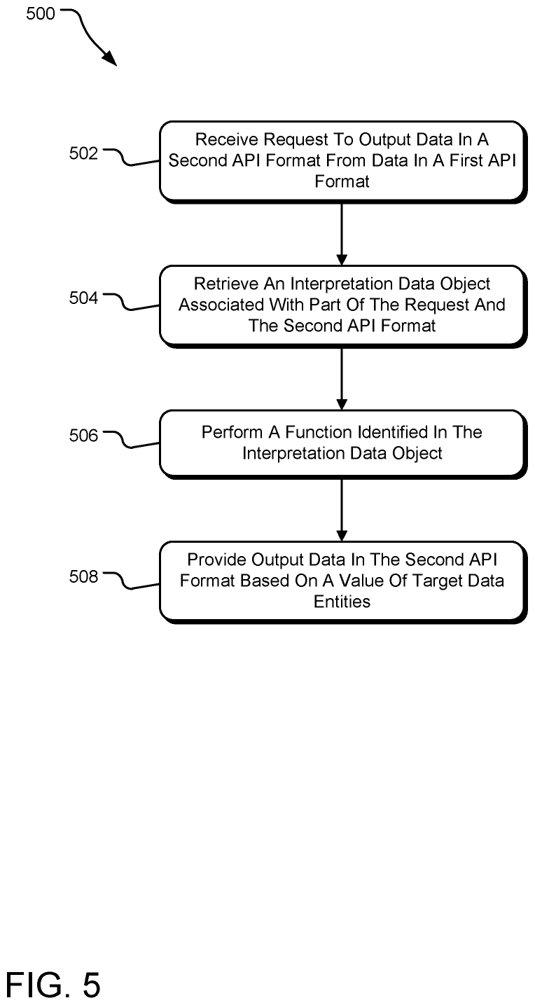

FIG. 5 illustrates example operations 500 for translating input data in a first application programming format into output data in a second application programming format. Receiving operation 502 receives a request to provide output data in a second application programming format from input data in a first application format. The commander may have previously received a request from a requesting entity in a second application programming format for data to be provided by a system that uses a first application programming data format. The commander may request responsive data from a system that uses the first application programming format. The commander may then transmit a translation request to a translator. The request may include input data and/or parameter data (e.g., data provided in a call to a translator). The commander may have also formatted the input data in a hierarchical structure that can be readily related by a translator to key identifiers in an interpretation data object. The receiving operation 502 is receiving by the translator the request and corresponding data transmitted by the commander in a request (or call) for translation. The input data may be received as a discrete file (e.g., a JSON file or other file) or by reference to a discrete input data object (e.g., an object composed of string data). The parameters and/or values of those parameters may be passed within the input data object and/or the parameters may be specified by reference in a passed string to be parsed by the translator. The translator may populate a variable table with one or more of identifiers of the passed parameters (e.g., source data entities represented in the first application programming format) and the parameter values.

Retrieving operation 504 retrieves an interpretation data object associated with at least part of the received request and the second application programming format. In an implementation, the interpretation data object includes data representing one or more source data entities in the first application programming format and one or more corresponding target data entities in the second application programming format.

The interpretation data object can be packaged in any type of data format. For example, the interpretation data object can be a discrete file or a discrete collection of data that is otherwise identifiable and retrievable. In an implementation, the interpretation data object is formatted as a string, for example, as a JSON format object or file. The interpretation data object 130 may include steps with commands (e.g., ones executable by a System Commander and/or ones in a first application programming format) and associated operations. Each operation may include data representing one or more source data entities in the first application programming format and one or more corresponding target data entities in the second application programming format and functions to operate on values of the one or more source data entities to generate at least one value of the one or more corresponding target data entities. In an implementation, each operation includes only one target data entity and/or results in producing only one output value for the target data entity. Also, in some implementations, each operation includes only one function. Data entities may be properties or other variables of systems that can be identified and retrieved as elements of requests. The translator may provide the output data in the second API format to a commander or other system of the translation service.

In implementations, data input into the translator can include parameters passed from the commander or other administrator of the translation service. The parameters may include values of the one or more source data entities. The parameters may be passed as string data. In an implementation, when more than one parameter is passed, the parameters are passed as a single string to be parsed by the translator. The translator may parse the single string and/or assemble any passed parameters into a variable table for use in a translation. In translations where no parameters are passed, the parameter string may be passed as an empty string. The parameters may be passed as parameter variables, or “pVariables” (illustrated in examples as elements in brackets starting with the letter, “p”). By passing the parameters as pVariables, the system can be adaptive and not use hard-coded values.

The performing operation 506 performs a function identified in the interpretation data object. The function may be performed on a value of the one or more source data entities to yield a value of the one or more corresponding target data entities based on an association included in the interpretation data object between the function, the one or more source data entities, and the one or more target data entities.

Functions are operations applied to values of source data entities to yield target data entities. The functions may be specified in the interpretation data object, but instructions for performing the functions may be elements of the translator. This may separate the roles of the translator, which may contain elements generally expected to remain the same when systems and APIs change, and the interpretation data object, which may likely be modified when system values or APIs change. The interpretation data object may contain references to data entities and functions for each operation of each step, but it may be limited to a reference element that does not execute any particular function. The translator may retrieve the interpretation data object to reference these relationships between entities and the functions used to translate the data entities in the relationships, but most if not all of the functionality may be elements of the translator. For example, the translator may retrieve the interpretation data object to reference which source data entities to retrieve, what function(s) to perform on the source data entities, and what target data entity to reference to store the result in output data.

The interpretation data object may not itself execute anything but exist as a reference for this purpose. Further, the interpretation data object may reference source and target data entities using key identifiers, but the translator may be the entity with the functionality to translate between the key identifiers and identifiers of the data entities to be presented in input and output data objects (e.g., in the first and second application programming formats, respectively). Further, the translator may interpret the hierarchical organization of the source data entities based on the structure provided in the input data to relate to source data entity keys and the hierarchical organizations to relate target data entity keys to output data. This structure may provide an interpretation data object containing only or predominantly reference data that can be executed by other objects. This interpretation data object can be readily modified to accommodate changes to the first and second application programming formats, as it may involve exclusively or predominantly modification of the reference to the commands, data entities, and/or the functions.

Examples of function operands may include, without limitation, one or more of ST_INVALID, ST_NONE, ST_ADD, ST_CONSTANT, ST_DIVIDE, ST_ENUM, ST_FORMAT, ST_MEMBER, ST_MULTIPLY, ST_PERCENT, ST_SELECT, ST_SUBTRACT, and ST_VARIABLE. Some functions may be merely to reference and/or copy values from data entities in a first application programming format to locations in output data that represent and are referenced as target data entities. These may include, for example, functions represented by function operands ST_NONE and ST_CONSANT.

Other functions may be transformational, for example, functions represented by operands ST_ADD, ST_MULTIPLY, ST_PERCENT, ST_DIVIDE, ST_ENUM, ST_MULTIPLY 100, and ST_SUBTRACT. Some other functions transform using table values to associate source and destination data entities, for example, functions represented by functional operands ST_Variable, ST_SELECT, ST_MEMBER, ST_FORMAT, and ST_ENUM. The interpretation data object may also contain an unknown function type, which can cause an ST_INVALID operand to be returned. This may cause termination of the function. Table 1 provides explanations of these exemplary function operands.

Further functions may specify an optional “table property.” This may be used to perform a transformation of source data entity values based on an enumeration table, link formula, or filter. Exemplary translation functions with optional table properties include ST_ENUM, ST_FORMAT, ST_MEMBER, and ST_SELECT, as explained in Table 2.

In implementations, the translator uses translator variables, or “tVariables” (illustrated in examples as elements in brackets starting with the letter, “t”). Translator variables can be used in translation operations to process the translation. Exemplary translator variables may include one or more of {tSource}, {tSource1}, {tSource2}, {tMemberIndex}, and {tMemberCount}, as described in Table 3. The tVariables may be internal variables of the translator.

The interpretation data object may use a special “key” identifier syntax to inform a translator to relate a data entity to a corresponding identifier in an input or output data file. Data entities (e.g., source data entities and/or target data entities) may be represented in input or output data as hierarchically arranged data entities in the first or second application programming format. Examples of this “key” syntax are presented in Table 4 as emboldened entries.

One or more of interpretation data objects, input data (provided in response to a request), or output data (translated from the input data) may be in any format. For example, they may be entirely or largely composed of strings (e.g., in JSON format). The string data can be interpreted within the JSON format or any other format as conforming to different data types when used by the requesting entity (e.g., when the requesting entity receives a response based on output data output by the translator and interprets data type properties for target data entity values in output data).

The translation operation conducted by the translator can proceed using a number of different workflows. One example workflow begins with clearing any prior variable table settings and then updating the variable table using a pVariables string passed in by the caller if any parameters are elements of the input data. In an implementation, only the pVariable type variables are converted at this point, since the tVariables may be used later for other steps in the process. In an implementation, during a translate step, the input data has already been retrieved from a SystemCommander of the translation entity. The translator may process each “step” individually and sequentially using data in the interpretation data object. Each operation listed for a step may be processed. In an implementation, each operation may be performed in three steps. In a first step, for each source value specified, retrieve that property from the source input data using the key format specified, including the optional use of pVariables and tVariables, and store it in an array of strings. There may be a few special handlers for certain source functions (e.g., ST_CONSTANT, ST_MEMBER, or ST_VARIABLE, as explained with regard to Tables 1 and 2). In a second step, the translator uses a defined “function” to transform the source values into one or more destination values (e.g., functions described with regards to Tables 1 and 2). In a third step, each target data entity value is stored in the output data (e.g., an output JSON file) based on the data type specified. All steps and commands may be processed. In some implementations, the steps and commands are processed sequentially with respect to the order and/or manner the steps and commands are presented in the interpretation data object.

Providing operation 508 provides the output data in the second application programming format based on the value of the one or more corresponding target data entities. The resulting output data is then returned to the system commander or other entity in order to be transmitted to a requesting entity. In implementations where the translated elements of the output data only comprise a piece of the output data, the translated output data may be coalesced or otherwise combined with the other output data to make an overall output data package or file to be supplied to a requesting entity. The output data may be provided as a single file (e.g., a JSON or other string-formatted output file). The output data may be hierarchically arranged in a manner specified by target key values in the interpretation data object. A commander may provide the output data to a requesting entity as is or may further format the data. The output data may be formatted to allow a translation service system to provide the data in a manner ingestable by the requesting entity system that uses the second application programming format.

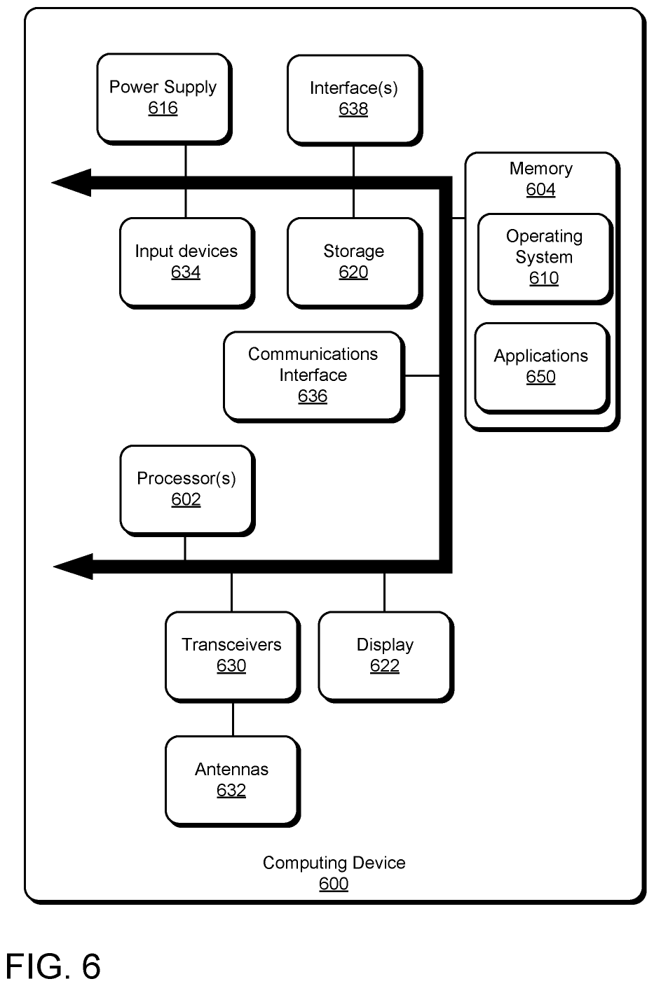

FIG. 6 illustrates an example computing device 600 for implementing the features and operations of the described technology. The computing device 600 may embody a remote-control device or a physical controlled device and is an example network-connected and/or network-capable device and may be a client device, such as a laptop, mobile device, desktop, tablet; a server/cloud device; an internet-of-things device; an electronic accessory; or another electronic device. The computing device 600 includes one or more processor(s) 602 and a memory 604. The memory 604 generally includes both volatile memory (e.g., RAM) and nonvolatile memory (e.g., flash memory). An operating system 610 resides in the memory 604 and is executed by the processor(s) 602. In implementations, one or more of requesting entity 102, API 1 System 103, translation service 110, translator 114, commander 212, cloud 190, API 2 system 107, and source entity 106 may be or include independent computing devices 600 or may be elements of or included in a same computing system 600.

In an example computing device 600, as shown in FIG. 6, one or more modules or segments, such as applications 650, translators, commanders, client systems, source systems, management controllers, command-line interfaces, execute( ) functions, executeAndTranslate( ) functions, MC framework containers, executeCommandToText( ) functions, processResults( ) functions, string or other data parsers, functions to be executed by translators, and translation services are loaded into the operating system 610 on the memory 604 and/or storage 620 and executed by processor(s) 602. The storage 620 may include one or more tangible storage media devices and may store interpretation data objects, pVariables, tVariables, input data, output data, requests, steps, commands, operations, functions, target data and/or source data entities, target data and/or source data identifier keys, target and/or source data identifiers in a first and/or second application programming format, data format types, associating data for identifying an appropriate interpretation data object, parameters, BufferStreams, data to parse hierarchical structures of data, and data representing relationships between key identifiers and identifiers of data entities in the first or second application programming format, locally and globally unique identifiers, requests, responses, and other data and be local to the computing device 600 or may be remote and communicatively connected to the computing device 600.

The computing device 600 includes a power supply 616, which is powered by one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers and/or client devices (e.g., mobile devices, desktop computers, or laptop computers). The computing device 600 may further include a network adapter 636, which is a type of computing device. The computing device 600 may use the adapter and any other types of computing devices for establishing connections over a wide-area network (WAN) or local-area network (LAN). It should be appreciated that the network connections shown are examples and that other computing devices and means for establishing a communications link between the computing device 600 and other devices may be used.

The computing device 600 may include one or more input devices 634 such that a user may enter commands and information (e.g., a keyboard or mouse). These and other input devices may be coupled to the server by one or more interfaces 638, such as a serial port interface, parallel port, or universal serial bus (USB). The computing device 600 may further include a display 622, such as a touch screen display.

The computing device 600 may include a variety of tangible processor-readable storage media and intangible processor-readable communication signals. Tangible processor-readable storage can be embodied by any available media that can be accessed by the computing device 600 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that includes one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

An example method is provided. The method includes receiving a request to provide output data in a second application programming format from input data in a first application programming format, retrieving an interpretation data object associated with at least part of the received request and the second application programming format, wherein the interpretation data object includes data representing one or more source data entities in the first application programming format and one or more corresponding target data entities in the second application programming format, performing a function identified in the interpretation data object, the function performed on a value of the one or more source data entities to yield a value of the one or more corresponding target data entities based on an association included in the interpretation data object between the function, the one or more source data entities, and the one or more target data entities, and providing the output data in the second application programming format based on the value of the one or more corresponding target data entities.

Another example method of any preceding method is provided, wherein the input data includes at least one input parameter that represents the value of the one or more source data entities.

Another example method of any preceding method is provided, wherein a call to initialize a translation includes more than one parameter, and the more than one parameter are passed as a single string, the operation of performing a function further including parsing the single string to identify the value of the one or more source data entities, and populating a variable table with the value of the one or more source data entities.

Another example method of any preceding method is provided, wherein the function includes a transformation on values of more than one of the one or more source data entities to yield the value of the one or more corresponding target entities.

Another example method of any preceding method is provided, wherein the operations of receiving, retrieving, performing, and providing are conductible by a translator using the interpretation data object and wherein the translator is operable to perform the function identified in the interpretation data object.

Another example method of any preceding method is provided, wherein the interpretation data object is a discrete file retrievable by a translator responsive to the request.

Another example method of any preceding method is provided, wherein the data representing one or more source data entities includes at least one source key associated with the one or more source data entities in the first application programming format and the data representing one or more target data entities includes at least one target key associated with the one or more target data entities in the second application programming format, wherein the operation of performing the function includes referencing the source keys to retrieve the value of the one or more source data entities and referencing output keys to output the value of the one or more target data entities.

An example computing device is provided. The example computing device includes a processor and a memory, the processor operable to execute instructions stored in memory. The computing device includes a translator executable by the processor and operable to receive a request to provide output data in a second application programming format from input data in a first application programming format, retrieve an interpretation data object associated with at least a part of the received request and the second application programming format, wherein the interpretation data object includes data representing one or more source data entities in the first application programming format and one or more corresponding target data entities in the second application programming format, wherein the interpretation data object is a discrete file retrievable by the translator responsive to the request, perform a function identified in the interpretation data object, the function performed on a value of the one or more source data entities to yield a value of the one or more corresponding target data entities based on an association included in the interpretation data object between the function, the one or more source data entities, and the one or more target data entities, and provide the output data in the second application programming format based on the value of the one or more corresponding target data entities.

Another example computing device of any preceding device is provided, wherein the input data includes at least one input parameter that represents the value of the one or more source data entities.

Another example computing device of any preceding device is provided, wherein the at least one input parameter includes more than one parameter, and the more than one parameter are passed as a single string, the translator further operable to:

parse the single string to identify the value of the one or more source data entities; and

populate a variable table with the value of the one or more source data entities.

Another example computing device of any preceding device is provided, wherein the function includes a transformation on values of more than one of the one or more source data entities to yield the value of the one or more corresponding target entities.

Another example computing device of any preceding device is provided, wherein one or more of the input data and the output data are formatted as string data.

Another example computing device of any preceding device is provided, wherein the interpretation data object provides a reference to the one or more target data entities, the one or more source data entities, and functions the translator is operable to perform, but the interpretation data object does not provide any transformative functionality and wherein the translator is operable to perform any transformative functionality referenced in the interpretation data object.

Another example computing device of any preceding device is provided, wherein the data representing one or more source data entities includes at least one source key associated with the one or more source data entities in the first application programming format and the data representing one or more corresponding target data entities includes at least one target key associated with the one or more target data entities in the second application programming format, the translator further operable to reference the source keys to retrieve the value of the one or more source data entities and reference output keys to output the value of the one or more target data entities.

One or more tangible processor-readable storage media embodied with instructions for executing on one or more processors and circuits of a computing device, a process for translating input data in a first application programming format to output data in a second application programming format is provided. The process includes retrieving an interpretation data object associated with at least part of a received request and the second application programming format, wherein the interpretation data object includes data representing one or more source data entities in the first application programming format and one or more corresponding target data entities in the second application programming format, performing a function identified in the interpretation data object, the function performed on a value of the one or more source data entities to yield a value of the one or more corresponding target data entities based on an association included in the interpretation data object between the function, the one or more source data entities, and the one or more target data entities, and providing the output data in the second application programming format based on the value of the one or more corresponding target data entities.

One or more other example tangible processor-readable storage media of any preceding media is provided, wherein the input data includes at least one input parameter that represents the value of the one or more source data entities.

One or more other example tangible processor-readable storage media of any preceding media is provided, wherein the at least one input parameter includes more than one parameter, and the more than one parameter are passed as a single string, the operation of performing a function further including parsing the single string to identify the value of the one or more source data entities and populating a variable table with the value of the one or more source data entities.

One or more other example tangible processor-readable storage media of any preceding media is provided, wherein the function includes a transformation on values of more than one of the one or more source data entities to yield the value of the one or more corresponding target entities.

One or more other example tangible processor-readable storage media of any preceding media is provided, wherein the interpretation data object is a discrete file retrievable by a command system responsive to the received request.

One or more other example tangible processor-readable storage media of any preceding media is provided, wherein the data representing one or more source data entities includes at least one source key associated with the one or more source data entities in the first application programming format and the data representing one or more corresponding target data entities includes at least one target key associated with the one or more target data entities in the second application programming format, wherein the performance of the function includes referencing the source keys to retrieve the value of the one or more source data entities and referencing output keys to output the value of the one or more target data entities.

An example system is provided. The system includes means for receiving a request to provide output data in a second application programming format from input data in a first application programming format, means for retrieving an interpretation data object associated with at least part of the received request and the second application programming format, wherein the interpretation data object includes data representing one or more source data entities in the first application programming format and one or more corresponding target data entities in the second application programming format, means for performing a function identified in the interpretation data object, the function performed on a value of the one or more source data entities to yield a value of the one or more corresponding target data entities based on an association included in the interpretation data object between the function, the one or more source data entities, and the one or more target data entities, and means for providing the output data in the second application programming format based on the value of the one or more corresponding target data entities.

Another example system of any preceding system is provided, wherein the input data includes at least one input parameter that represents the value of the one or more source data entities.

Another example system of any preceding system is provided, wherein a call to initialize a translation includes more than one parameter, and the more than one parameter are passed as a single string, the means for performing a function further including means for parsing the single string to identify the value of the one or more source data entities and means for populating a variable table with the value of the one or more source data entities.

Another example system of any preceding system is provided, wherein the function includes a transformation on values of more than one of the one or more source data entities to yield the value of the one or more corresponding target entities.

Another example system of any preceding system is provided, wherein the reception, retrieval, performance and, and provision are conductible by a translator using the interpretation data object and wherein the translator is operable to perform the function identified in the interpretation data object.

Another example system of any preceding system is provided, wherein the interpretation data object is a discrete file retrievable by a translator responsive to the request.

Another example system of any preceding system is provided, wherein the data representing one or more source data entities includes at least one source key associated with the one or more source data entities in the first application programming format and the data representing one or more target data entities includes at least one target key associated with the one or more target data entities in the second application programming format, wherein the means for performing the function includes means for referencing the source keys to retrieve the value of the one or more source data entities and means for referencing output keys to output the value of the one or more target data entities.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

1. A method comprising:
receiving a request to provide output data in a second application programming format from input data in a first application programming format;
retrieving an interpretation data object associated with at least part of the received request and the second application programming format, wherein the interpretation data object includes data representing one or more source data entities in the first application programming format and one or more corresponding target data entities in the second application programming format;
performing a function identified in the interpretation data object, the function performed on a value of the one or more source data entities to yield a value of the one or more corresponding target data entities based on an association included in the interpretation data object between the function, the one or more source data entities, and the one or more target data entities; and
providing the output data in the second application programming format based on the value of the one or more corresponding target data entities.

2. The method of claim 1, wherein the input data includes at least one input parameter that represents the value of the one or more source data entities.

3. The method of claim 2, wherein a call to initialize a translation includes more than one parameter, and the more than one parameter are passed as a single string, the operation of performing a function further comprising:
parsing the single string to identify the value of the one or more source data entities; and
populating a variable table with the value of the one or more source data entities.

4. The method of claim 1, wherein the function includes a transformation on values of more than one of the one or more source data entities to yield the value of the one or more corresponding target entities.

5. The method of claim 4, wherein the operations of receiving, retrieving,
performing, and providing are conductible by a translator using the interpretation data object and wherein the translator is operable to perform the function identified in the interpretation data object.

6. The method of claim 1, wherein the interpretation data object is a discrete file retrievable by a translator responsive to the request.

7. The method of claim 1, wherein the data representing one or more source data entities includes at least one source key associated with the one or more source data entities in the first application programming format and the data representing one or more target data entities includes at least one target key associated with the one or more target data entities in the second application programming format, wherein the operation of performing the function includes:
referencing the source keys to retrieve the value of the one or more source data entities; and
referencing output keys to output the value of the one or more target data entities.

8. A computing device including a processor and a memory, the processor operable to execute instructions stored in memory, the computing device comprising:
a translator executable by the processor and operable to:
receive a request to provide output data in a second application programming format from input data in a first application programming format;
retrieve an interpretation data object associated with at least a part of the received request and the second application programming format, wherein the interpretation data object includes data representing one or more source data entities in the first application programming format and one or more corresponding target data entities in the second application programming format, wherein the interpretation data object is a discrete file retrievable by the translator responsive to the request;
perform a function identified in the interpretation data object, the function performed on a value of the one or more source data entities to yield a value of the one or more corresponding target data entities based on an association included in the interpretation data object between the function, the one or more source data entities, and the one or more target data entities; and
provide the output data in the second application programming format based on the value of the one or more corresponding target data entities.

9. The computing device of claim 8, wherein the input data includes at least one input parameter that represents the value of the one or more source data entities.

10. The computing device of claim 9, wherein the at least one input parameter includes more than one parameter, and the more than one parameter are passed as a single string, the translator further operable to:
parse the single string to identify the value of the one or more source data entities; and
populate a variable table with the value of the one or more source data entities.

11. The computing device of claim 8, wherein the function includes a transformation on values of more than one of the one or more source data entities to yield the value of the one or more corresponding target entities.

12. The computing device of claim 11, wherein one or more of the input data and the output data are formatted as string data.

13. The computing device of claim 8, wherein the interpretation data object provides a reference to the one or more target data entities, the one or more source data entities, and functions the translator is operable to perform, but the interpretation data object does not provide any transformative functionality and wherein the translator is operable to perform any transformative functionality referenced in the interpretation data object.

14. The computing device of claim 8, wherein the data representing one or more source data entities includes at least one source key associated with the one or more source data entities in the first application programming format and the data representing one or more corresponding target data entities includes at least one target key associated with the one or more target data entities in the second application programming format, the translator further operable to:
reference the source keys to retrieve the value of the one or more source data entities; and
reference output keys to output the value of the one or more target data entities.

15. One or more tangible processor-readable storage media embodied with instructions for executing on one or more processors and circuits of a computing device, a process for translating input data in a first application programming format to output data in a second application programming format, the process comprising:
retrieving an interpretation data object associated with at least part of a received request and the second application programming format, wherein the interpretation data object includes data representing one or more source data entities in the first application programming format and one or more corresponding target data entities in the second application programming format;
performing a function identified in the interpretation data object, the function performed on a value of the one or more source data entities to yield a value of the one or more corresponding target data entities based on an association included in the interpretation data object between the function, the one or more source data entities, and the one or more target data entities; and
providing the output data in the second application programming format based on the value of the one or more corresponding target data entities.

16. The one or more tangible processor-readable storage media of claim 15, wherein the input data includes at least one input parameter that represents the value of the one or more source data entities.

17. The one or more tangible processor-readable storage media of claim 16, wherein the at least one input parameter includes more than one parameter, and the more than one parameter are passed as a single string, the operation of performing a function further comprising:
parsing the single string to identify the value of the one or more source data entities; and
populating a variable table with the value of the one or more source data entities.

18. The one or more tangible processor-readable storage media of claim 15, wherein the function includes a transformation on values of more than one of the one or more source data entities to yield the value of the one or more corresponding target entities.

19. The one or more tangible processor-readable storage media of claim 15, wherein the interpretation data object is a discrete file retrievable by a command system responsive to the received request.

20. The one or more tangible processor-readable storage media of claim 15, wherein the data representing one or more source data entities includes at least one source key associated with the one or more source data entities in the first application programming format and the data representing one or more corresponding target data entities includes at least one target key associated with the one or more target data entities in the second application programming format, wherein the performance of the function includes:
referencing the source keys to retrieve the value of the one or more source data entities; and
referencing output keys to output the value of the one or more target data entities.
